(19) United States
(12) Patent Application Publication
(10) Pub. No.: US 2007/0166658 A1
(43) Pub. Date: Jul. 19, 2007

(54) SELF-LIGATING ORTHODONTIC BRACKET WITH MID-UNDERCUT

(75) Inventor: John C. Voudouris, Toronto (CA)

Correspondence Address: MICHAEL BEST & FRIEDRICH, LLP, 100 E WISCONSIN AVENUE, Suite 3300, MILWAUKEE, WI, 53202, US

(73) Assignee: CERAMIC SCIENCES, INC., Toronto (CA)

(21) Appl. No.: 11/622,653

(22) Filed: Jan. 12, 2007

Related U.S. Application Data
(60) Provisional application No. 60/758,707, filed on Jan. 13, 2006.

(51) Int. Cl. A61C 3/00

(52) U.S. Cl. 433/10

(57) ABSTRACT

An orthodontic bracket comprising a body and a locking member movable coupled to the body. The body defines an archwire slot and has a labial surface and a lingual surface. The body also includes an undercut positioned between the labial surface and the lingual surface. The locking member engages the undercut and is pivotable relative to the body between a closed position where access to the archwire slot in inhibited and an open position where access to the archwire slot is permitted. In one embodiment, the body has a mesial-distal width, and the undercut extends across substantially the entire mesial-distal width of the body. In a different embodiment, the undercut extends across only a portion of the mesial-distal width of the body. In another aspect, the locking member includes a head portion for closing the archwire slot when the locking member is in the closed position and having a first mesial-distal width, a neck portion having a second mesial-distal width less than the first mesial-distal width, and a tail portion for engaging the body and having a third mesial-distal width greater than the second mesial-distal width (e.g., substantially equal to the first mesial-distal width. In one embodiment, the bracket further includes two tie wings coupled to the body, and the neck portion is positioned between the two tie wings.

### REFERENCE TO RELATED APPLICATIONS

This application claims priority to U.S. Provisional Patent Application No. 60/758,707, filed Jan. 13, 2006, the entire contents of which are hereby incorporated by reference herein.

### FIELD OF THE INVENTION

The present invention relates generally to the field of orthodontics and, more specifically, to the field of self-ligating orthodontic brackets.

### BACKGROUND

According to established orthodontic techniques, it is well known to attach an orthodontic bracket to a patient's tooth. The bracket provides a location for attaching an arch wire and other orthodontic devices to facilitate movement of the tooth. According to established orthodontic techniques, it is well known to ligate an arch wire to the orthodontic bracket utilizing an elastic or metal ligature. In conventional orthodontic brackets, the ligature is wrapped around respective gingival and occlusal tie wings so as to overlay the arch wire at mesial and distal ends of the orthodontic bracket.

Recently, designers have created self-ligating brackets that do not require a separate ligature for attachment of the arch wire to the bracket. One type of self-ligating bracket is supplied with a locking member that is movable between an open position, permitting access to the arch wire slot, and a closed position, inhibiting access to the arch wire slot. Self-ligating brackets substantially decrease the time involved in performing ligation procedures.

### SUMMARY

The present invention provides an orthodontic bracket comprising a body and a locking member movable coupled to the body. The body defines an archwire slot and has a labial surface and a lingual surface. The body also includes an undercut positioned between the labial surface and the lingual surface. The locking member engages the undercut and is pivotable relative to the body between a closed position where access to the archwire slot in inhibited and an open position where access to the archwire slot is permitted. In one embodiment, the body has a mesial-distal width, and the undercut extends across substantially the entire mesial-distal width of the body. In a different embodiment, the undercut extends across only a portion of the mesial-distal width of the body.

In another aspect, the present invention provides an orthodontic bracket having a body and a locking member pivotable relative to the body between a closed position where access to the archwire slot in inhibited and an open position where access to the archwire slot is permitted. The locking member includes a head portion for closing the archwire slot when the locking member is in the closed position and having a first mesial-distal width, a neck portion having a second mesial-distal width less than the first mesial-distal width, and a tail portion for engaging the body and having a third mesial-distal width greater than the second mesial-distal width (e.g., substantially equal to the first mesial-distal width. In one embodiment, the bracket further includes two tie wings coupled to the body, and the neck portion is positioned between the two tie wings.

### BRIEF DESCRIPTION OF THE DRAWINGS

FIG. 1 is a top perspective view of an orthodontic bracket according to a first embodiment of the present invention.

FIG. 2 is a rear perspective view of the orthodontic bracket of FIG. 1 with the locking member removed.

FIG. 3 is a side view of the bracket of FIG. 1 with the locking member in a closed position.

FIG. 4 is a side view of the bracket of FIG. 1 with the locking member in an open position.

FIG. 5 is a top perspective view of an orthodontic bracket according to a second embodiment of the present invention.

FIG. 6 is a perspective view of the locking member used in the embodiment of FIG. 1.

FIG. 7 is a perspective exploded view of an orthodontic bracket according , to a third embodiment of the present invention.

FIG. 8 is a perspective exploded view of an orthodontic bracket according to a fourth embodiment of the present invention.

FIG. 9 is a side view, partially in section, of an orthodontic bracket according to a fifth embodiment of the present invention with the locking member in a closed position.

FIG. 10 is the side view of FIG. 9 with the locking member in a partially open position.

FIG. 11 is the side view of FIG. 9 with the locking member in an open position.

FIG. 12 is a side view, partially in section, of an orthodontic bracket according to a sixth embodiment of the present invention with the locking member in an open position.

FIG. 13 is an exploded perspective view of an orthodontic bracket according to a seventh embodiment of the present invention.

### DETAILED DESCRIPTION

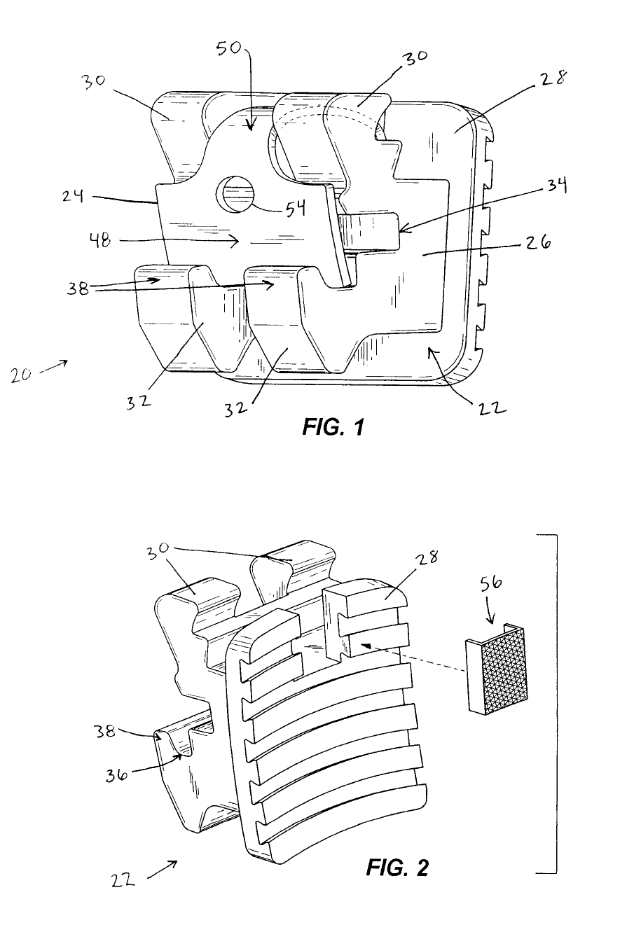

The orthodontic bracket 20 illustrated in FIGS. 1-4 includes a base 22 and a moveable locking member 24. The base 22 includes a body 26 attached to a pad 28 having a lingual surface for attachment to a tooth. The body 26 and pad 28 can be integrally formed or, alternatively, can be formed separately and subsequently attached together. The base 22 can be made from a variety of materials, including metal (e.g., stainless steel), plastic, or ceramic.

The illustrated base 22 includes two gingival tie wings 30 and two occlusal tie wings 32. An archwire slot 34 is formed in the base 22 and is aligned with the mesial-distal direction, as is known in the art. The base 22 further includes two retention notches 36 near the archwire slot 34 and defining two retention lips 38 for retaining the locking member 24 in position, as described below in more detail. The base 22 further includes a recess 40 in a labial face 42 near the gingival tie wings 30.

The base 22 further defines a mid-undercut 44 formed by a ledge 46 positioned lingually of the gingival tie wings 30. In the illustrated embodiment, the ledge 46 extends across the full mesial-distal width of the body 26.

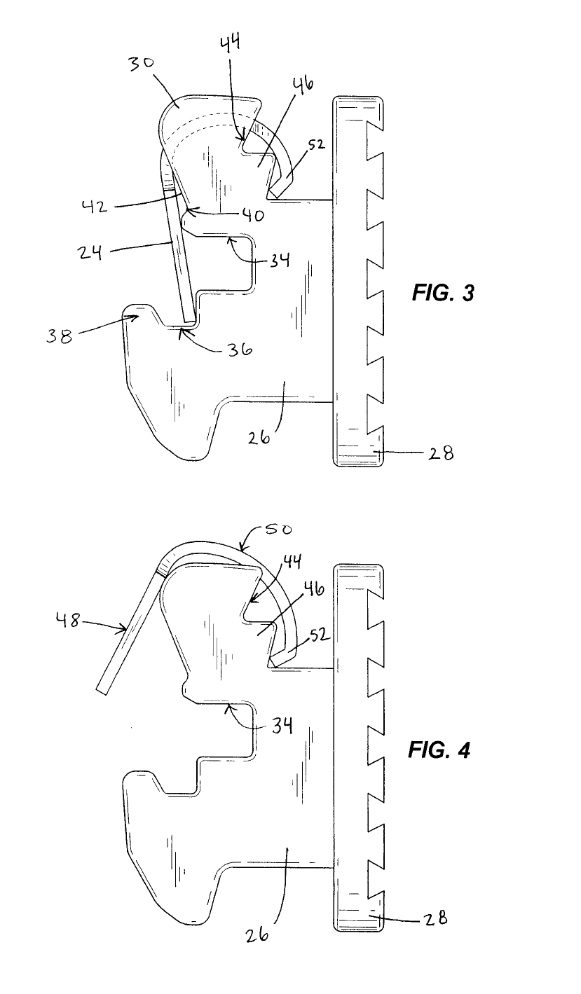

The locking member 24 is substantially T-shaped and includes a head portion 48 and a neck portion 50. The head portion 48 is substantially the full mesial-distal width of the body 26 and is designed to be moved from a closed position covering the archwire slot 34 (FIG. 3) and an open position allowing access to the archwire slot 34 (FIG. 4). In the closed position (FIG. 3), the free end of the head portion 48 is positioned in the notch 36. In this position, labial movement of the head portion 48 is restricted by the retention lips 38.

The neck portion 50 has a mesial-distal width less than the mesial-distal width of the head portion, and is dimensioned to fit between the two gingival tie wings 30. As shown in FIGS. 3 and 4, one end of the neck portion 50 is connected to the head portion 48, and the free end of the neck portion 50 is tucked under the ledge 46 in the mid-undercut 44. The free end of the neck portion 50 includes a sharp bend 52 that tucks into the mid-undercut 44.

The locking member 24 further includes an opening 54 that is dimensioned to receive a tool that facilitates opening and closing of the locking member 24.

In order to facilitate assembly of the orthodontic bracket 20 of FIG. 1, the pad 28 includes a removable retention member 56, as shown in FIG. 2. During assembly, the retention member portion 56 is removed from the pad 28, which allows the locking member 24 to be assembled to the body 26 with the free end of the neck portion 50 tucked into the mid-undercut 44. After the locking member 24 is assembled to the body 26, the retention member 56 can be secured to the pad 28 (e.g., by welding, braising, bonding, press fit, or any other appropriate method). The retention member 56 includes a lingual surface that is textured to enhance bonding to a tooth

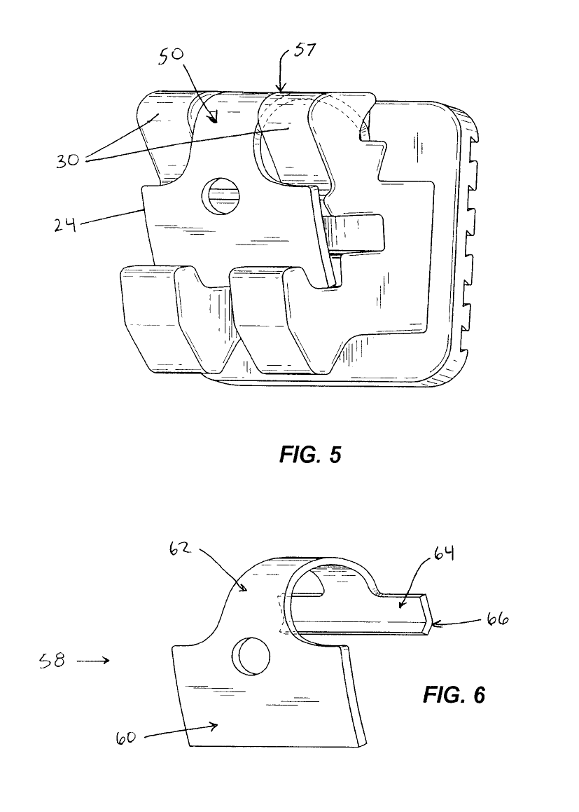

FIG. 5 illustrates a second embodiment, similar to the embodiment of FIGS. 1-4. In this embodiment, the length of the neck portion 50 has been increased so that the gingival edge of the neck portion 50 is substantially flush with the gingival edge 57 of the gingival tie wings 30 when the locking member 24 is in the closed position. It is believed that this will enhance the comfort of the bracket 20 in the user's mouth.

FIG. 6 illustrates an alternative locking member 58 that can be used with the base 22 illustrated in FIGS. 1-4. As can be seen, the illustrated locking member 58 has a head portion 60 and a neck portion 62, similar to the locking member 24 of FIGS. 1-4, and further includes a tail portion 64 having a mesial-distal width that is wider than the mesial-distal width of the neck portion 62. The result is a bar-bell shaped locking member 58. In the illustrated embodiment, the tail portion 64 is substantially the same mesial-distal width as the head portion 60, which corresponds with the mesial-distal width of the body 26. The tail portion 64 further includes a sharp bend (66 near its free edge so that the free edge of the tail portion 64 can tuck into the mid-undercut 44, The locking member 58 of FIG. 6 alleviates the need to have the ledge 46 and mid-undercut 44 extend across the full mesial-distal width of the body 26. More specifically, the space between the gingival tie wings 30 can be extended lingually to remove the ledge 46 in that region.

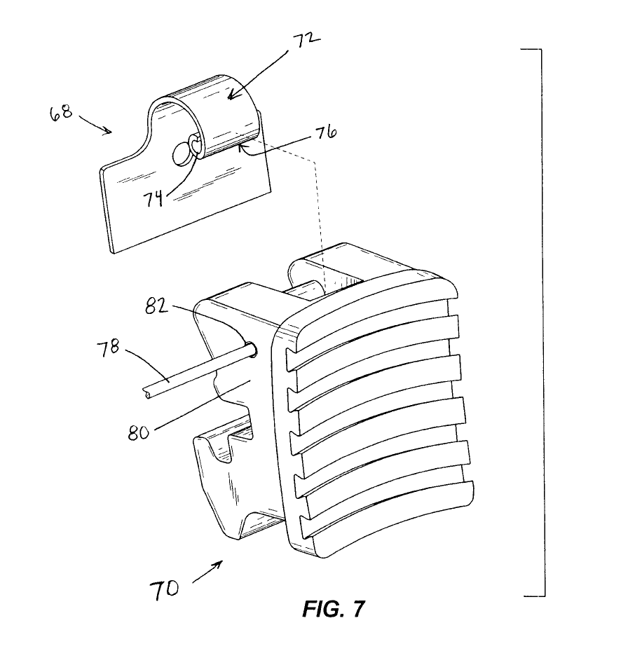

Referring to FIG. 7, the third embodiment of the present invention illustrates an alternative way to secure the locking member 68 to the base 70. In this embodiment, the locking member 68 includes a neck portion 72 having a free end with a mesial-distal opening 74 formed by a looped portion 76. The opening 74 is designed to receive a pivot rod 78 to facilitate pivoting of the locking member 68 relative to the base 70. During assembly, the locking member 68 is positioned onto the body 80, and the pivot rod 78 is inserted through a hole 82 in the side of the body 80 and secured in place (e.g., by braising, welding, bonding, press fit, or any other appropriate method).

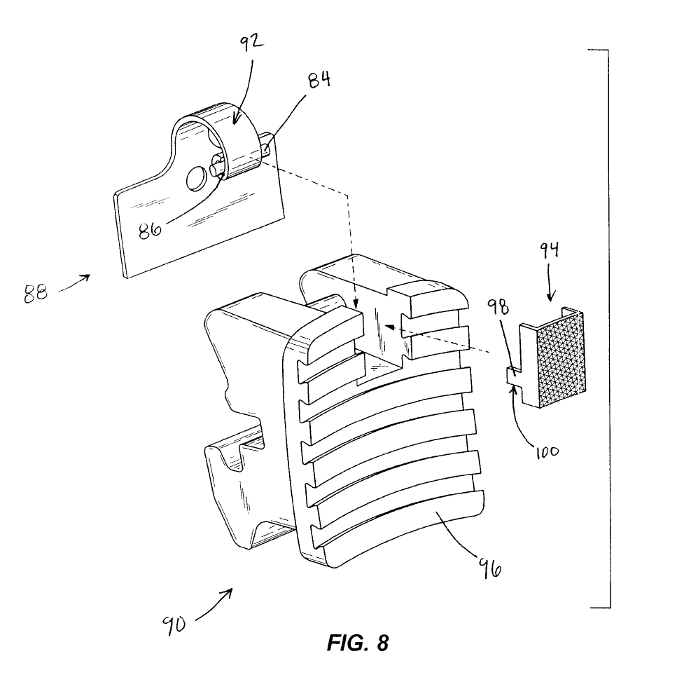

FIG. 8 illustrates a fourth embodiment that is a variation of the third embodiment illustrated in FIG. 7. In this embodiment, the pivot rod 84 is shorter and is inserted through the looped portion 86 prior to mounting the locking member 88 onto the base 90. The pivot rod 84 is longer than the mesial-distal width of the neck portion 92 so that the ends of the pivot rod 84 are exposed. After the locking member 88 is assembled to the base 90, a removable retention member 94 is attached to the pad 96 to secure the pivot rod 84 in place. More specifically, the retention member 94 includes tabs 98 that define retention notches 100 that are dimensioned to receive the free ends of the pivot rod 84 when the retention member 94 is attached to the pad 96. The tabs 98 substantially prevent the pivot rod 84 from becoming detached from the base 90. The retention member 94 includes a lingual surface that is textured to enhance the bonding to a tooth.

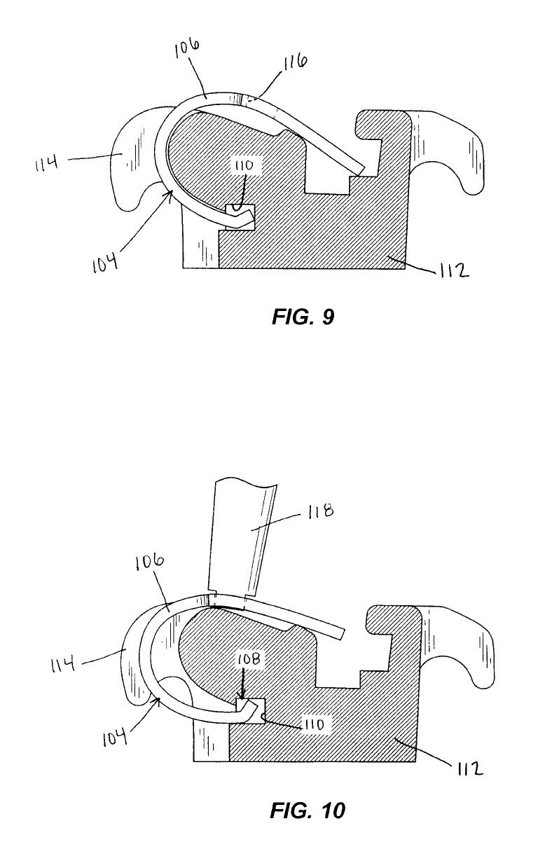

FIGS. 9-11 illustrate another embodiment of the present invention wherein the free end of the neck portion 104 of the locking member 106 is tucked into a mid-undercut 108 defined by a square-crossed section orifice 110 extending through the body 112 in the mesial-distal direction. The orifice 110 is positioned such that a portion of the wall defining the orifice 110 is removed in the region between the tie wings 114 to define a mid-undercut 108.

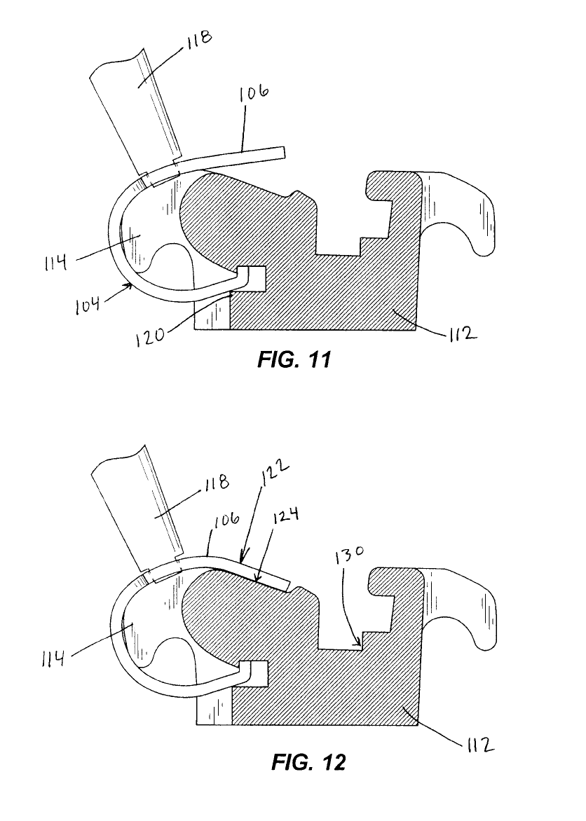

Similar to the previous embodiments, the locking member 106 of the embodiment of FIGS. 9-11 includes an opening 116 adapted to receive a tool 118 that facilitates opening and closing of the locking member 106. Referring to FIG. 11, it can be seen that when in the open position, the free end of the neck portion 104 engages a stop 120 to inhibit further rotation of the locking member 106.

FIG. 12 illustrates an orthodontic bracket similar to that illustrated in FIGS. 9-11, except that the locking member 106 is made from a highly-resilient material. As a result of this high resiliency, it can be seen that the head portion 122 of the locking member 106 is biased lingually so that, when the locking member 106 is in the open position, the head portion 122 is positioned substantially in contact with the labial surface 124 of the body 112. By virtue of this the head portion 122 of the locking member 106 is moved out of the way, reducing of the archwire slot 130 when the locking member 106 is in the open position.

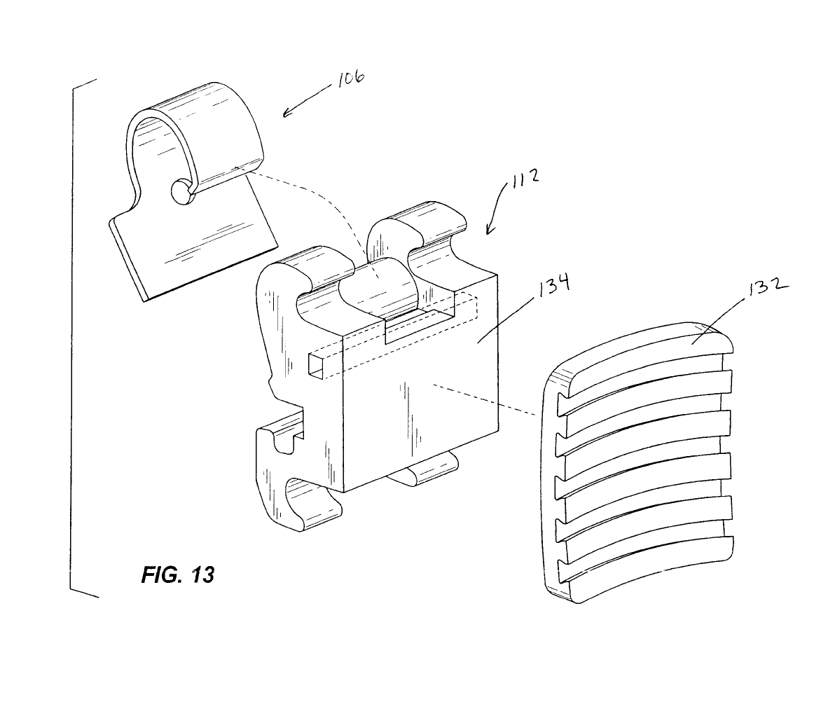

FIG. 13 illustrates a slight variation of the bracket illustrated in FIGS. 9-11. In this embodiment, a bonding pad 132 can be secured to the lingual surface 134 of the body 112 to provide an increased surface area for securing the bracket to a tooth. With proper dimensioning, it is also believed that attaching the bonding pad 132 as a separate step will facilitate the assembly of the locking member 106 to the body 112 prior to attachment of the pad 132.

What is claimed is:

1. An orthodontic bracket comprising:
a body defining an archwire slot and having a labial surface and a lingual surface, the body including an undercut positioned between the labial surface and the lingual surface; and
a locking member engaging the undercut and pivotable relative to the body between a closed position where access to the archwire slot in inhibited and an open position where access to the archwire slot is permitted.

2. The orthodontic bracket of claim 1, wherein the body has a mesial-distal width, and wherein the undercut extends across substantially the entire mesial-distal width of the body.

3. The orthodontic bracket of claim 1, wherein the body has a mesial-distal width, and wherein the undercut extends across only a portion of the mesial-distal width of the body.

4. The orthodontic bracket of claim 1, further comprising a tie wing coupled to the body, wherein the undercut is positioned labially from the tie wing.

5. The orthodontic bracket of claim 1, further comprising two tie wings coupled to the body, wherein a portion of the locking member is positioned between the two tie wings.

6. The orthodontic bracket of claim 5, wherein the locking member includes:
a head portion for closing the archwire slot when the locking member is in the closed position, the head portion having a first mesial-distal width;
a neck portion having a second mesial-distal width less than the first mesial-distal width; and
a tail portion engaging the undercut.

7. The orthodontic bracket of claim 6, wherein the tail portion has a third mesial-distal width greater than the second mesial-distal width.

8. The orthodontic bracket of claim 7, wherein the third mesial-distal width is substantially equal to the first mesial-distal width.

9. The orthodontic bracket of claim 1, further comprising a pad secured to the lingual surface of the body.

10. The orthodontic bracket of claim 9, wherein the pad and body cooperatively define a base, and wherein the base includes a retention member that, when removed from the rest of the base, facilitates assembly of the locking member onto the base.

11. An orthodontic bracket comprising:
a body defining an archwire slot and having a labial surface and a lingual surface; and
a locking member pivotable relative to the body between a closed position where access to the archwire slot in inhibited and an open position where access to the archwire slot is permitted, wherein the locking member includes:
a head portion for closing the archwire slot when the locking member is in the closed position, the head portion having a first mesial-distal width;
a neck portion having a second mesial-distal width less than the first mesial-distal width; and
a tail portion for engaging the body and having a third mesial-distal width greater than the second mesial-distal width.

12. The orthodontic bracket of claim 11, further comprising two tie wings coupled to the body, and wherein the neck portion is positioned between the two tie wings.

13. The orthodontic bracket of claim 11, wherein the third mesial-distal width is substantially equal to the first mesial-distal width.

14. The orthodontic bracket of claim 1, further comprising a pad secured to the lingual surface of the body.

15. The orthodontic bracket of claim 14, wherein the pad and body cooperatively define a base, and wherein the base includes a retention member that, when removed from the rest of the base, facilitates assembly of the locking member onto the base.
